(19) United States
(12) Patent Application Publication
(10) Pub. No.: US 2014/0122120 A1
(43) Pub. Date: May 1, 2014

(54) SYSTEMS AND METHODS FOR PROVIDING PHOTO-BASED PATIENT VERIFICATION FOR USE WITH IMPLANTABLE MEDICAL DEVICE PROGRAMMERS

(71) Applicant: PACESETTER, INC., Sylmar, CA (US)

(72) Inventor: Berj A. Doudian, Sun Valley, CA (US)

(21) Appl. No.: 13/663,987

(22) Filed: Oct. 30, 2012

(51) Int. Cl. G06F 19/00

(52) U.S. Cl. CPC G06F 19/321
USPC 705/3

(57) ABSTRACT

In one example, prior to device interrogation, identifier data is received by the external system from the implanted device. Based on the identifier data, the external system retrieves a digital photograph representative of the particular patient in which the device is implanted. The system displays the retrieved image to the clinician to allow visual verification that data received corresponds to the particular patient whose device is to be interrogated.

### FIELD OF THE INVENTION

The invention generally relates to programmers or other external instruments for use with implantable medical devices and, in particular, to device interrogation and related procedures.

### BACKGROUND OF THE INVENTION

A wide range of implantable medical devices are provided for surgical implantation within patients such as cardiac pacemakers, implantable cardioverter defibrillators (ICDs), cardiac resynchronization therapy (CRT) devices or other implantable cardiac rhythm management devices (CRMDs.) Still other implantable medical devices include Spinal Cord Stimulation (SCS) devices, Deep Brain Stimulation (DBS) devices or the like. Implantable medical devices, particularly CRMDs, are often configured for use with a device programmer or other external instrument, which allows a clinician to program the operation of the implanted device to control, for example, specific parameters by which the device detects an arrhythmia and responds thereto. Additionally, the programmer may be configured to receive and display a wide variety of diagnostic information detected by the implanted device, such as intracardiac electrograms (IEGMs) sensed within the patient.

Typically, a programming session begins with the device programmer interrogating the implanted device via radio-frequency (RF) telemetry to download data from the device, such as programmable parameters, stored IEGMs and diagnostic data pertaining to device operation. Traditionally, short-range telemetry was employed wherein a telemetry wand was placed over the chest of the patient to interrogate the device. However, medium-range and long-range RF communication techniques could instead be used to interrogate devices in the general vicinity of the device programmer. As such, circumstances can arise where multiple patients might be within the communication range of the device programmer, potentially resulting in downloading of data from a device within the wrong patient. That is, the clinician may believe data has been properly received from the implanted device within a particular patient, whereas the data was instead downloaded from the device of a different patient in the general proximity. If not detected by the clinician, the error could result in misdiagnosis of medical conditions within the patient and/or erroneous re-programming of device parameters, possibly triggering unwarranted pacing therapy within the patient or a failure to deliver needed therapy. As can be appreciated, the longer the range of RF communication, the more likely a number of patients may be within interrogation range of the device and the greater the chance of a device misidentification error. Such problems can arise, for example, during a post-implant “follow up” session with the patient. Similar problems can also occur when a clinician is merely reviewing archived patient data; that is, the clinician may erroneously think he or she is reviewing the archived data from one patient when data from another patient is being reviewed, leading to possible misdiagnoses of conditions.

Accordingly, it would be highly desirable to provide a simple and effective technique for avoiding the aforementioned device interrogation and patient identification problems, and it is to these ends that aspects of the invention are primarily directed. Other aspects of the invention are directed to providing a memory aid to help a clinician recall details of a patient when reviewing their chart, or when viewing patient information via a remote system.

### SUMMARY

In an exemplary embodiment, systems and methods are provided for use by an external system equipped to communicate with implantable medical devices for implant within patients. The external system may be, for example, a device programmer, bedside monitor or other external instrument equipped to interrogate and program implanted devices. In one example, data is received by the external system from a device implanted in a patient using medium-range or long-range RF communication wherein the received data includes identifier data. Based on the identifier data, the external system retrieves a digital photograph or other suitable image data representative of the particular patient in which the device is implanted. The external system displays the retrieved image to the clinician or other user of the system to allow visual verification that the data received by the external system corresponds to an intended patient whose device is to be interrogated and another patient also within communication range.

In this manner, the clinician, physician or other user of the external system can easily verify and corroborate that data received by the external system corresponds to a particular patient rather than another patient in the vicinity. Assuming the external system is found to be in communication with the implanted device of the intended patient, the clinician then proceeds with further device interrogation to download additional data, such as the current values of programmable pacing parameters, IEGM data and device diagnostic data. Otherwise, the clinician takes steps to correct the problem, such as by switching to a shorter-range communication technique to ensure that data received by the external system is received only from the device of the intended patient or otherwise choosing to interrogate the intended patient (i.e. if the clinician has inadvertently selected the wrong patient to begin with, the clinician can simply switch to the intended patient.)

In an illustrative example, the identifier data received from the implanted device identifies the particular device implanted within the patient using a serial number. Based on the serial number, the external system queries a database to determine the name of the patient whose implanted device corresponds to the serial number, as well as to retrieve a digital photograph corresponding to the patient for display. The database may be installed within the external system itself or within a remote system such as a centralized server accessed via the Internet. In other examples, the identifier data specifies the name of the patient, which is then used to retrieve the digital photograph. In still other examples, the identifier data itself includes the digital photograph. That is, the implantable device stores a digital photo of the patient within on-board memory, which is then transmitted to the external device for display.

Once the digital photograph is displayed to the clinician via the external system, the clinician verifies that the photo corresponds to the intended patient and enters an appropriate acknowledgement into the system, which then enables full interrogation and programming of the implanted device. That is, in this example, the photo-verification procedure is a pre-interrogation procedure performed prior to full interrogation of the device. In other examples, the photo-verification procedure may be performed concurrently with device interrogation and/or may be performed prior to any programming or reprogramming of the device. In still other examples, if several patient devices are within communication range of the external system, the system retrieves and displays digital photographs of each of the patients, as well as their names and the serial numbers of their devices. The clinician selects one of the patients for further device interrogation/programming, with the system then limiting its interrogation/programming commands to just the device of the selected patient. Although these techniques are particularly helpful when using medium-range or long-range telemetry (where multiple patients might be within communication range), it should be understood that aspects of the invention are applicable to short-range communication systems as well.

Still further, the digital photos are preferably displayed along with patient data when archived data is being reviewed by the clinician, either on screen or via printed reports. That is, photo-verification is not limited for use during device interrogation or programming. Rather, patient photos can be generated whenever patient data is to be reviewed. By displaying a photo of the patient while archived data is being reviewed, the photo can serve as a memory aid to the clinician, while also helping to avoid data misidentification problems. In addition to being displayed on the programmer in archive mode or on printed reports, the photo can also be displayed on a patient data website (such as the Merlin.net™ website) when reviewing patient information via such a site.

System and method implementations of these and other techniques are presented herein.

### BRIEF DESCRIPTION OF THE DRAWINGS

Features and advantages of the described implementations can be more readily understood by reference to the following description taken in conjunction with the accompanying drawings.

FIG. 1 illustrates pertinent components of a medical system having an external instrument for communication with a CRMD implanted within a patient, wherein the external instrument is equipped for photo-verification;

FIG. 2 summarizes a technique performed by the system of FIG. 1 for photo-verification wherein the external instrument retrieves a digital photo of the patient from a database using identifier data received from the CRMD;

FIG. 3 illustrates an exemplary patient photo-verification database for use with the system of FIG. 1;

FIG. 4 illustrates an exemplary implementation of the system of FIG. 1 where the photo-verification database is stored within the external instrument;

FIG. 5 illustrates an exemplary implementation of the system of FIG. 1 where the photo-verification database is instead stored within a remote system;

FIG. 6 summarizes an alternative technique performed by the system of FIG. 1 for photo-verification wherein the digital photo is received from the CRMD;

FIG. 7 illustrates an exemplary implementation of the system of FIG. 1 where the digital photo is stored within the CRMD;

FIG. 8 illustrates an exemplary display screen generated using the systems and techniques of FIGS. 1-7 showing a patient photo along with patient data and IEGM data, which may represent newly retrieved data or archived data;

FIG. 9 illustrates an exemplary printed report created using the systems and techniques of FIGS. 1-7 showing a patient photo along with patient data and IEGM data, which may represent newly retrieved data or archived data;

FIG. 10 illustrates an exemplary display screen generated using the systems and techniques of FIGS. 1-7 showing photos for a set of patients within communication range of the external instrument;

FIG. 11 illustrates an exemplary implementation of the system of FIG. 1 where the digital photo is displayed via a patient care website; FIG. 12 illustrates an exemplary website browser display screen generated using the system of FIG. 11 showing a patient photo along with patient data;

FIG. 13 is a simplified, partly cutaway view, illustrating the CRMD of FIG. 1 along with a set of leads implanted into the heart of the patient;

FIG. 14 is a functional block diagram of the CRMD of FIG. 13, illustrating basic circuit elements that provide cardioversion, defibrillation and/or pacing stimulation in the heart and particularly illustrating on-board components for providing patient identifier data for use with the systems and techniques of FIGS. 1-10; and

FIG. 15 is a functional block diagram illustrating components of the external programmer of FIG. 1, particularly illustrating components for controlling the systems and techniques of FIGS. 1-10.

### DETAILED DESCRIPTION OF THE PREFERRED EMBODIMENTS

The following description includes the best mode presently contemplated for practicing the invention. This description is not to be taken in a limiting sense but is made merely to describe general principles of the invention. The scope of the invention should be ascertained with reference to the issued claims. In the description of the invention that follows, like numerals or reference designators will be used to refer to like parts or elements throughout.

### Overview of Photo-Verification Systems and Methods

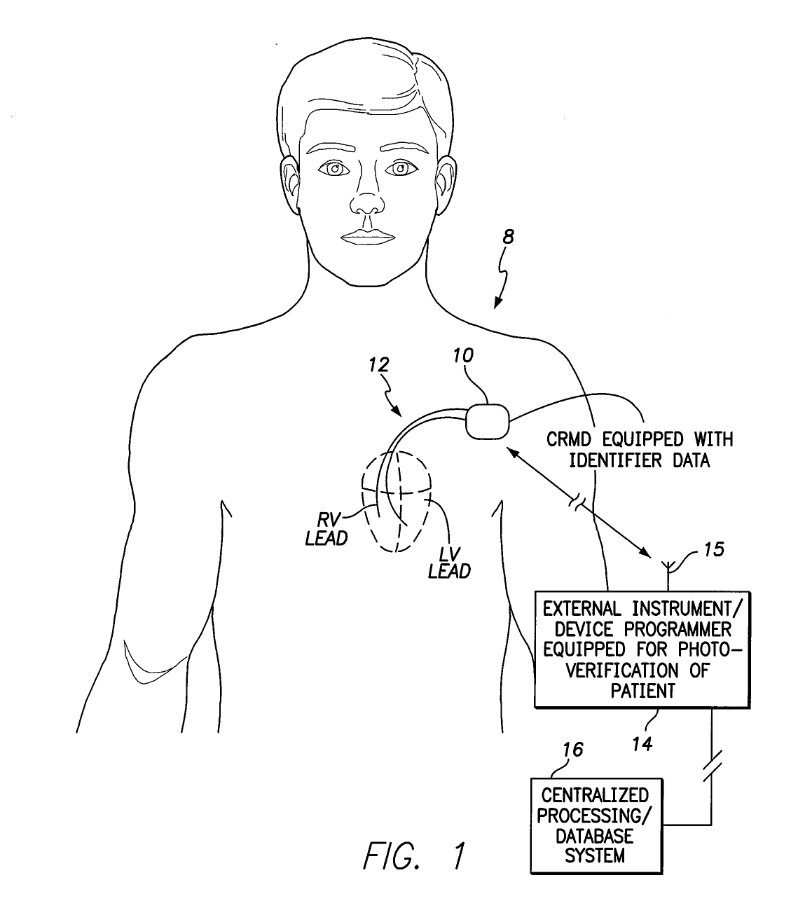

FIG. 1 illustrates an implantable medical system 8 having a CRMD 10 equipped with a set of cardiac sensing/pacing leads 12 implanted on or within the heart of the patient. CRMD 10 can be any suitably-equipped implantable medical device, such as a standalone pacemaker, ICD or CRT device, including CRT-D and CRT-P devices, or other implantable devices such as SCS devices or the like. The CRMD is in communication with an external system 14 using medium-range or long-range telemetry via an RF antenna or other suitable transceiver device 15. The external system may be, for example, a device programmer, bedside monitor or other external instrument that is equipped for photo-verification of patient identity. Briefly, in one example, the external system receives identifier data from the CRMD such as a serial number, then accesses a photo-verification database to retrieve a digital photo of the patient for display to the clinician to verify that external system 14 is properly in communication with the device of the intended patient prior to further interrogation or programming or the device. In other examples, the digital photo is received from the CRMD. As shown, the external system may operate in conjunction with a remote or centralized system 16 (using, e.g., the HouseCall™ system or the Merlin@home/Merlin.Net™ systems of St. Jude Medical).

### Exemplary Systems and Methods

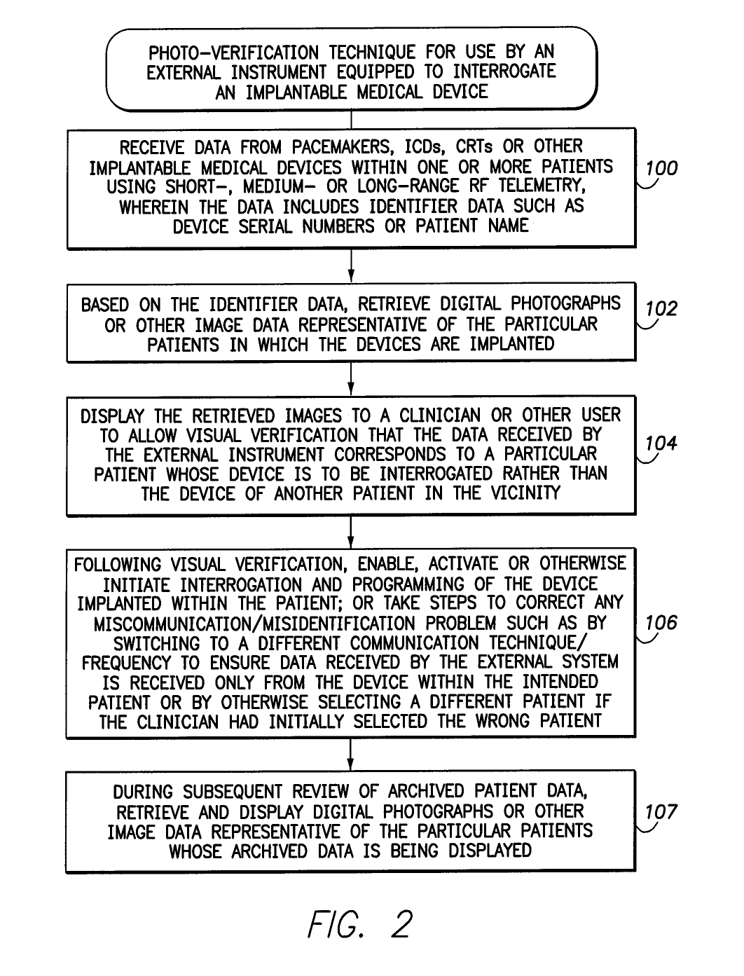

FIG. 2 summarizes the first exemplary verification technique performed by an external system in communication with a CRMD or other implantable medical device. Beginning at step 100, the external system receives data from pacemakers, ICDs, CRTs or other implantable medical devices within one or more patients using short-range, medium-range or long-range telemetry, wherein the received data includes identifier data such as device serial numbers or patient names. Depending upon the implementation, such medium-range or long-range communication systems might exploit Medical Implant Communication Service (MICS) radio transmissions or Medical Device Radiocommunications Service (MedRadio) transmissions. Systems and techniques for use with MICS/MedRadio communications are discussed, for example, in U.S. patent application Ser. No. 13/458,934, filed Apr. 27, 2012, of Amely-Velez et al., entitled “Electromagnetic Interference Shielding for use with an Implantable Medical Device Incorporating a Radio Transceiver” (Atty. Docket A12P1026) and in U.S. patent application Ser. No. 13/538,501, filed Jun. 29, 2012, of Li et al., entitled “Inverted E Antenna with Capacitance Loading for use with an Implantable Medical Device” (Atty. Docket A12P1033). Other communications protocols or frequency ranges might be used as well, such as Industrial, Scientific, and Medical (ISM) bands or Wireless Medical Telemetry Service (WMTS) bands. See, also, various long-range telemetry techniques discussed in U.S. Pat. No. 8,150,529 of Snell et al., entitled “Medical Devices and Systems having Separate Power Sources for Enabling Different Telemetry Systems” and in U.S. Patent Application 2012/0226140 of Min et al., entitled “Systems and Methods for remote Monitoring of Signals Sensed by an Implantable Medical Device during an MRI.” As noted above, although techniques described herein are particularly helpful when using medium-range or long-range telemetry (where multiple patients might be within communication range), the techniques are generally applicable to short-range communication systems as well.

At step 102, based on the received identifier data, the external system retrieves digital photographs or other image data representative of the particular patient or patients in which the devices are implanted. Examples are described below where the system accesses one or more databases to retrieve the image data based on device serial number, patient name or other identifier data. At step 104, the external system displays the retrieved image or images to a clinician or other user to allow visual verification that the data received by the external system corresponds to a particular patient whose device is to be interrogated rather than to the device of another patient in the vicinity. As already explained, the clinician, physician or other user of the external system can thereby easily verify that the data received by the external system corresponds to the intended patient rather than another patient. At step 106, following visual verification, the external system enables, activates or otherwise initiates interrogation and programming of the device implanted within the patient. Assuming the external system is found to be in proper communication with the implanted device of the intended patient, the clinician then proceeds with further device interrogation to download additional data such as the current values of programmable pacing parameters, IEGM data, device diagnostic data and patient diagnostic data. Otherwise, the clinician takes steps to correct the problem, such as by switching to a shorter-range communication technique to ensure that data received by the external system is received only from the device within the intended patient, switching to a different communication frequency if appropriate, or performing other steps as needed such as simply selecting a different patient if the clinician had inadvertently selected the wrong patient to begin with.

Techniques for use when multiple devices are within communication range are set forth in U.S. Pat. No. 8,175,715 to Cox, entitled “Frequency Agile Telemetry System for Implantable Medical Device.” Briefly, the system of the Cox patent implements a communication protocol in which an external system interrogates any implantable medical devices within range to establish one-to-one communication links for purposes of exchanging data and/or programming the medical devices. Device interrogation techniques are also discussed in U.S. Pat. No. 6,263,245 to Snell, entitled “System and Method for Portable Implantable Device Interrogation” and in U.S. Pat. No. 5,833,623 to Mann et al., entitled “System and Method for Facilitating Rapid Retrieval and Evaluation of Diagnostic Data stored by an Implantable Medical Device.”

At step 107, during subsequent review of archived patient data, the external system retrieves and displays digital photographs or other image data representative of the particular patients whose archived data is being displayed or printed out. As noted, the photos can serve as a memory aid to the clinician reviewing the data, while also helping to avoid patient misidentification problems that might occur if the clinician believes he or she is reviewing the data from one patient but is actually reviewing data from a different patient.

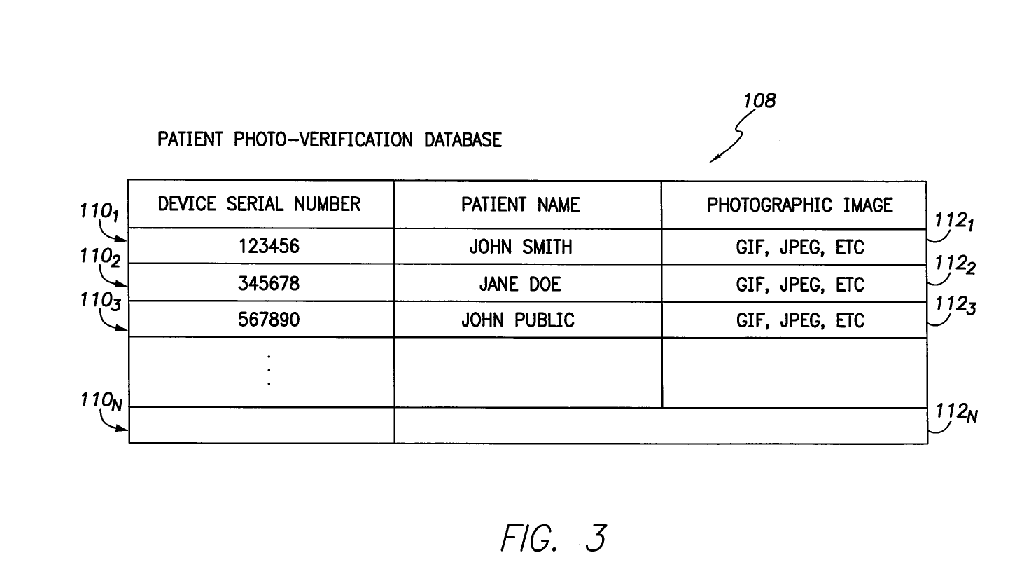

FIG. 3 illustrates an exemplary patient photo-verification database 108. Depending upon the particular implementation, the database may be maintained within external system 14 of FIG. 1, centralized system 16 or other remote locations, or may be distributed among various systems. In this particular example, database 108 includes a set of entries 110₁ . . . 110_{N} for storing information for each of several implanted devices, including the unique serial number for the device (typically provided by the device manufacturer), the name of the patient in which the particular device has been implanted and corresponding patient image data (112₁ . . . 112_{N}) for that particular patient in the form of Graphics Interchange Format (GIF) files, Joint Photographic Experts Group (JPEG) files or other suitable image formats. In use, following implant of a device into a patient, the serial number and patient name are entered into the database by the clinician. At that time, the clinician or other personnel may take a photo of the patient using a digital camera or the like for storing along with the patient name and serial number. Alternatively, if a suitable photo is already available, perhaps within preexisting clinic or hospital admission records, such a photo could instead be used. In any case, the external system thereafter uses the device serial number received via telemetry from a given implanted device to look up the patient name and corresponding image data for verification display.

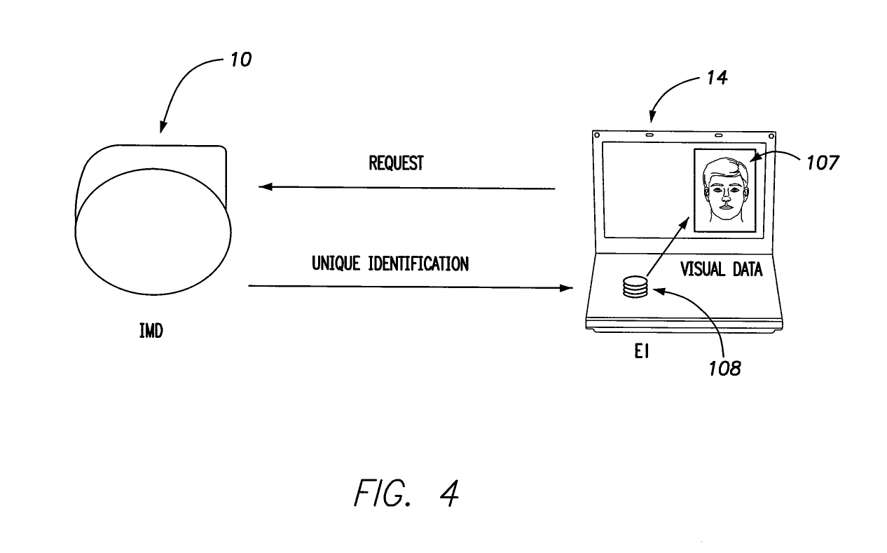

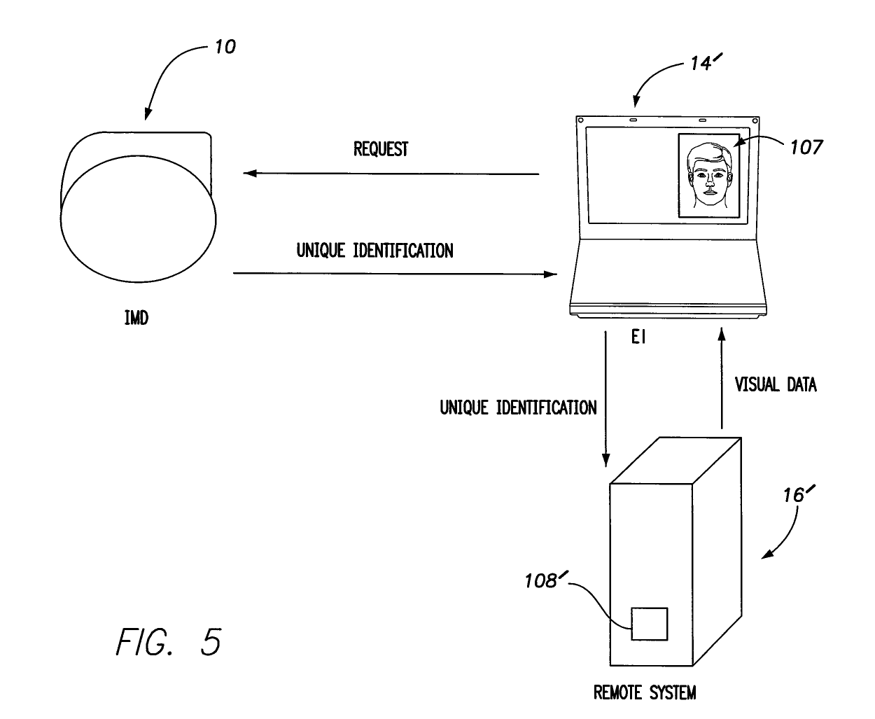

FIG. 4 illustrates an example wherein database 108 containing the image data or “visual data” is stored within external instrument (EI) 14. In this example, a request for device identifier data is sent to CRMD 10 (i.e. IMD 10) and a suitable unique identifier is received by the EI such as the serial number or patient name. The EI then displays the patient image 107 on its display screen for review by the clinician. (In the attached figures, to illustrate an exemplary photo without raising copyright or privacy issues, a drawing of the face of an exemplary patient is shown, but it should be understood that, in use, an actual digital photo of the particular patient would be displayed.) FIG. 5 illustrates an example where the database containing image data is stored within centralized system 16′. A request for device identifier data is sent to CRMD 10 and a suitable unique identifier is received, which is forwarded to the centralized system. The centralized system accesses its internal database 108′ to retrieve the patient image, then sends the image data to EI 14′ for display of image 107.

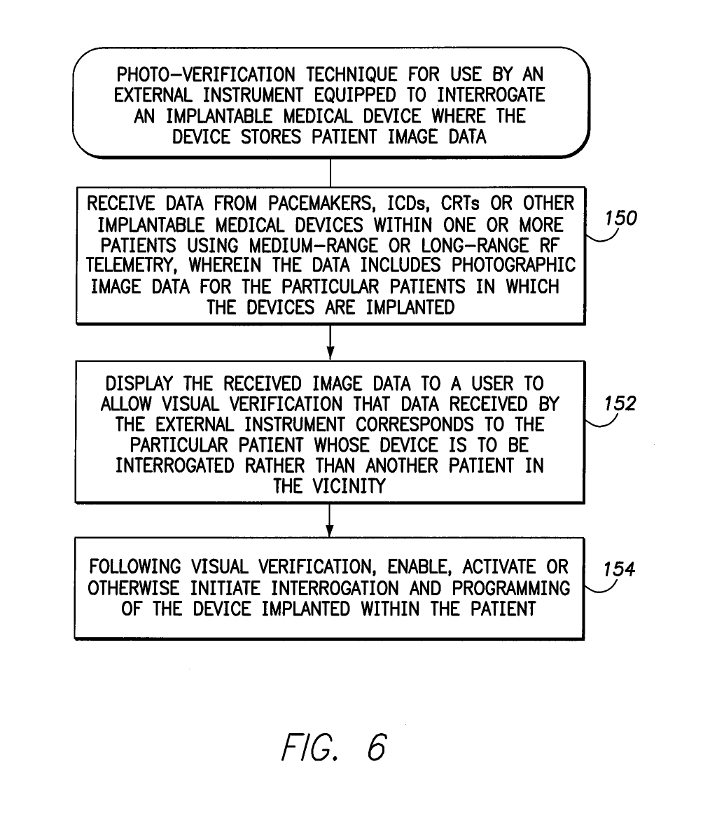

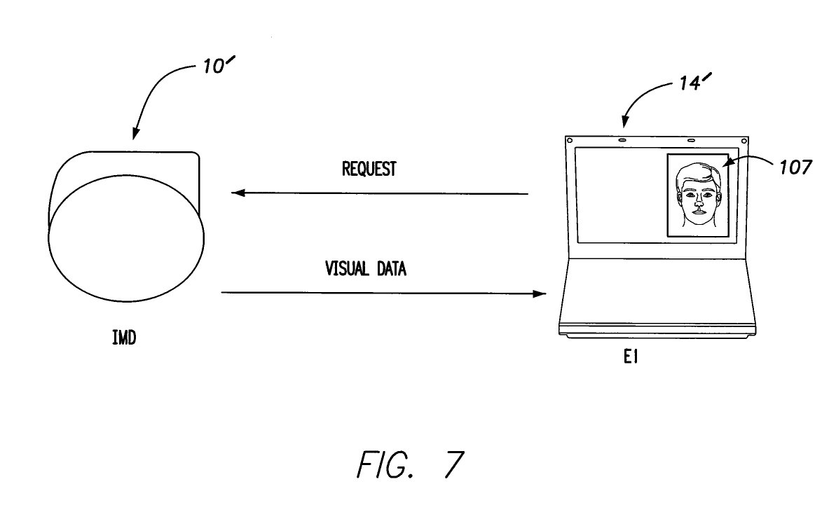

FIG. 6 summarizes the second exemplary verification technique wherein the image data for the patient photograph is stored within the implanted device itself. Beginning at step 150, the external system receives data from CRMDs or other implantable medical devices within one or more patients using medium-range or long-range RF telemetry, wherein the received data includes photographic image data for the particular patients in which the devices are implanted (along with other identifier data such as device serial numbers.) At step 152, the external system displays the received image or images to a clinician or other user to allow visual verification that the data received by the external system corresponds to a particular patient whose device is to be interrogated rather than another patient in the vicinity. At step 154, following visual verification, the external system enables, activates or otherwise initiates interrogation and programming of the device implanted within the patient. FIG. 7 illustrates a system configured to implement the method of FIG. 6 wherein visual image data is stored within a suitably-equipped CRMD 10′. A request for device identifier data is sent to the CRMD and the visual data is returned (typically along with other identifier data such as the serial number of the device.) The EI 14′ then displays the received image data 107 on its display for photo verification.

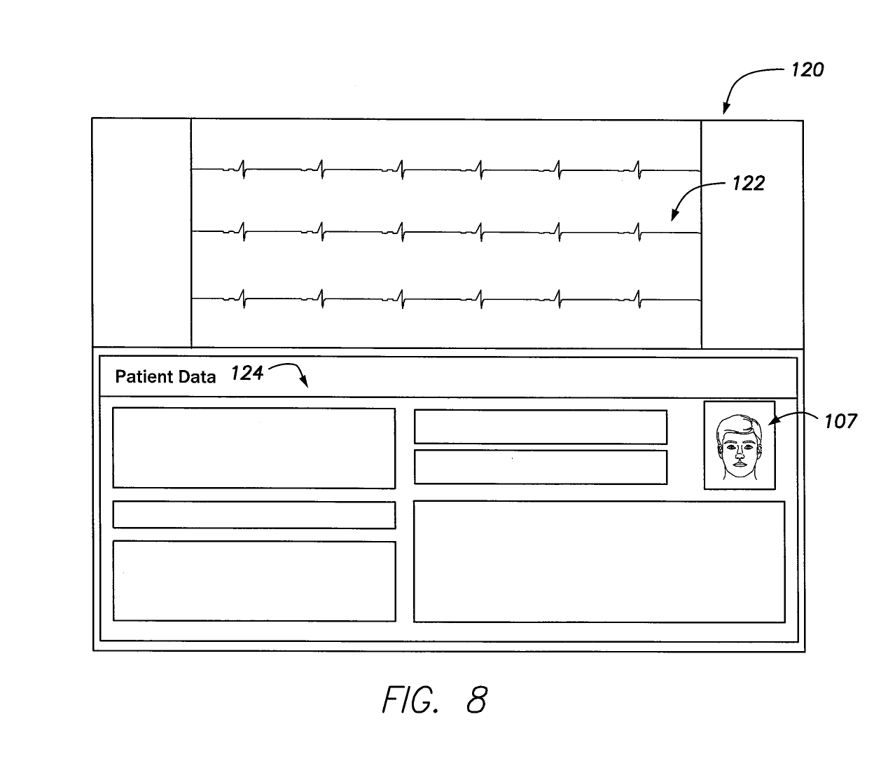

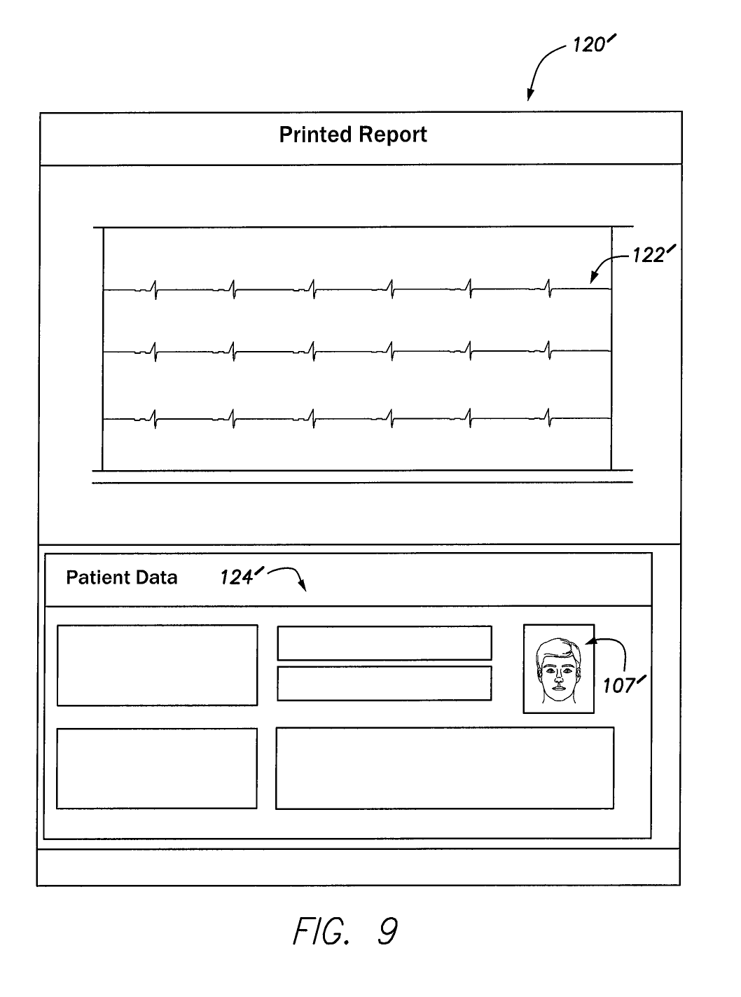

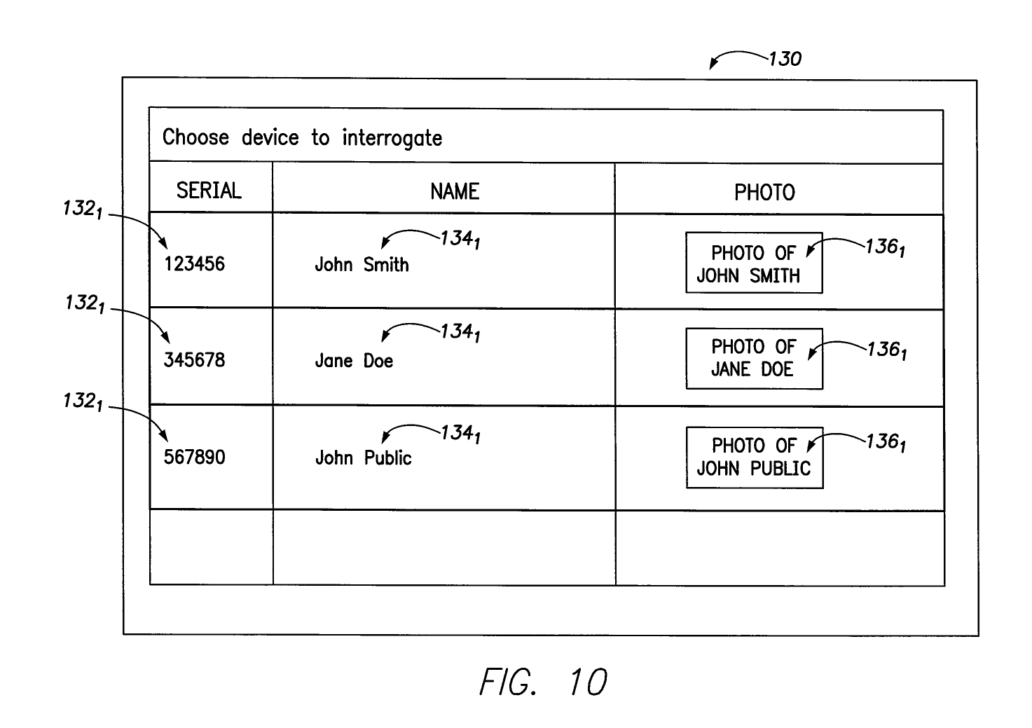

FIG. 8 illustrates an exemplary display that may be generated by the external system (i.e. the EI) in accordance with any of the above-described embodiments after the device has been interrogated to download IEGM data and other patient data. The display may also be generated based on previously downloaded and archived patient data. In this particular example, display 120 includes various IEGM traces 122, along with textual patient data 124 (such as patient name, etc.) and the visual image 107 of the patient. FIG. 9 illustrates a corresponding printout that may be printed by the external system (i.e. the EI); also in accordance with any of the above-described embodiments based on newly downloaded data previously archived data. As shown, printout 120′ includes various printed IEGM traces 122′, along with printed textual patient data 124′ and the printed image 107′ of the patient.

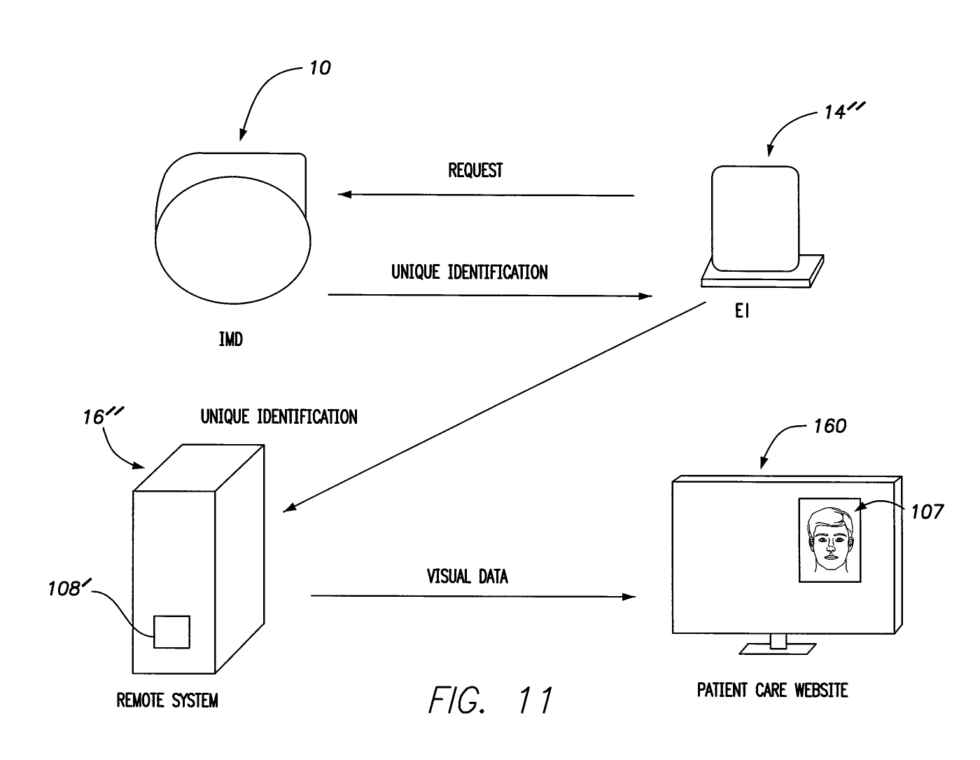

As noted above, in circumstances where several patients with implantable devices are within communication range of the external system, the system may retrieve patient identifiers for each of the patients and then display photos for each patient to thereby allow the user of the system to select which device to interrogate. An exemplary display 130 is shown in FIG. 10, which displays device serial numbers 132₁ . . . 132_{N}, patient names 134₁ . . . 134_{N} and digital photos 136₁ . . . 136_{N} for each respective patient. The user then selects a particular device for further interrogation. A similar display may also be generated based on archived data. That is, the names and photos of various patients whose data has been previously downloaded and archived can be displayed so the clinician can select a particular patient for archived data review.

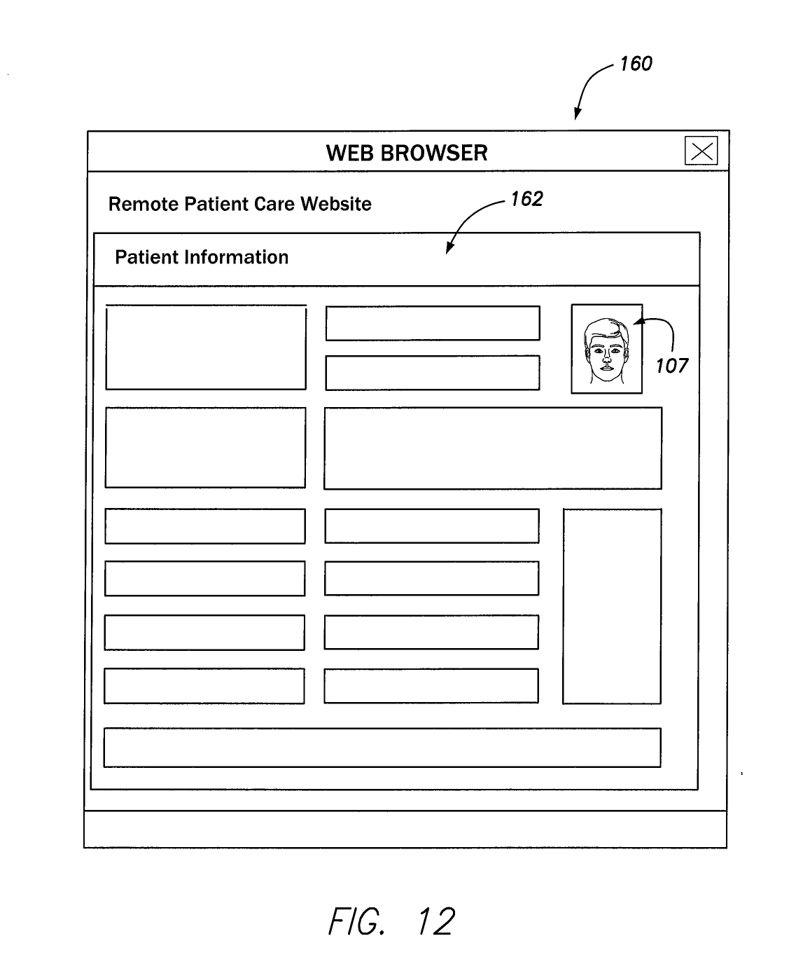

FIG. 11 illustrates an example wherein a remote patient care website (such as the aforementioned Merlin.net™ system) is used to display patient data. For example, a clinician may access this system when viewing archive session information or when performing a “remote followup” or “remote programming.”) In this particular example, a request for device identifier data is sent by the EI 14″ to CRMD 10 and a suitable unique identifier is received, which is forwarded to a remote database system 16″. The remote system accesses its internal database 108′ to retrieve the patient image and other patient data, then sends the image data and other data to a web browser 160 for display of image 107 within a patient care website. FIG. 12 illustrates an exemplary display that may be generated within a web browser 160 for displaying information via a patient care website. In this particular example, the browser displays patient information 162 (which may include IEGMs along with textual patient data) and the visual image 107 of the patient for use as a memory aid to the clinician or for other purposes.

What have described are various exemplary techniques for displaying visual images of patients to provide photo-verification during a follow up session with a patient or based on archived data. As can be appreciated, a wide range of variations and alternatives may be employed consistent with the general teachings herein. For example, in some cases, photo-verification might be employed during a follow up session only if more than one device is found to be within RF communication range of the EI. In other cases, photo-verification is always employed regardless of the number of devices found to be within communication range. In some instances, photo-verification is required before interrogation of the device. In other instances, interrogation proceeds automatically, with the photo of the patient then being displayed along with the interrogated data. In still other cases, photo-verification might be employed prior to device programming/reprogramming rather than prior to device interrogation. These are just some examples. Moreover, the techniques described herein may be implemented for use with a wide range of devices and external systems. For the sake of completeness, detailed descriptions of an exemplary CRMD and an exemplary device programmer will now be set forth. The invention can, of course, be implemented within other systems and other devices.

### Exemplary CRMD

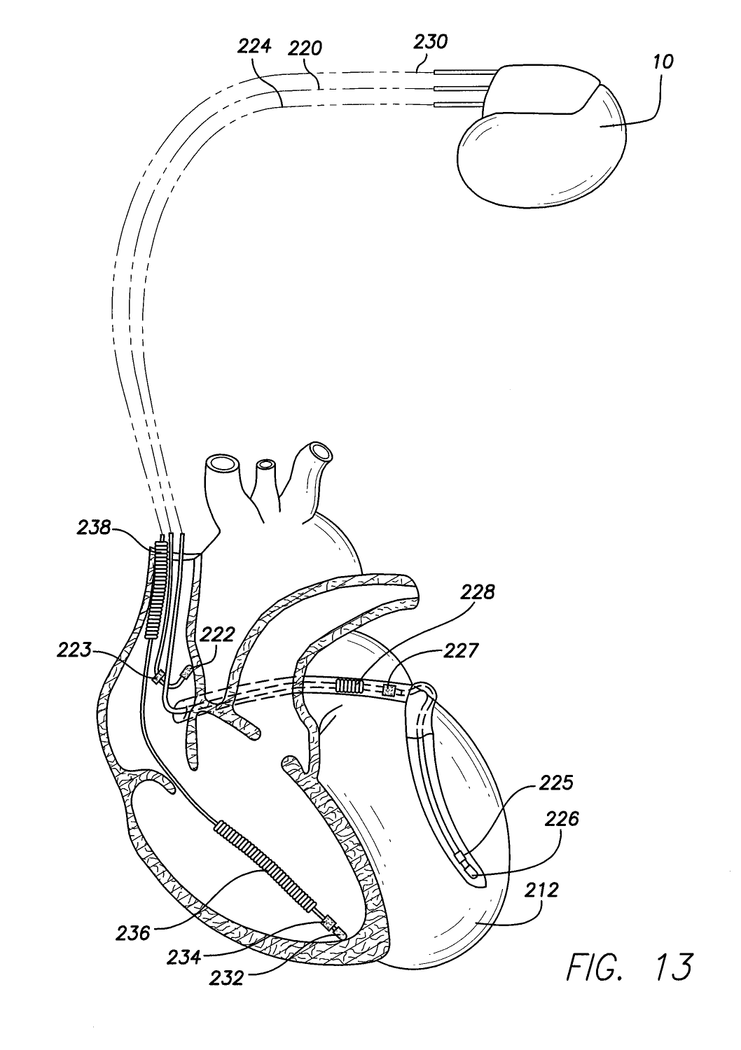

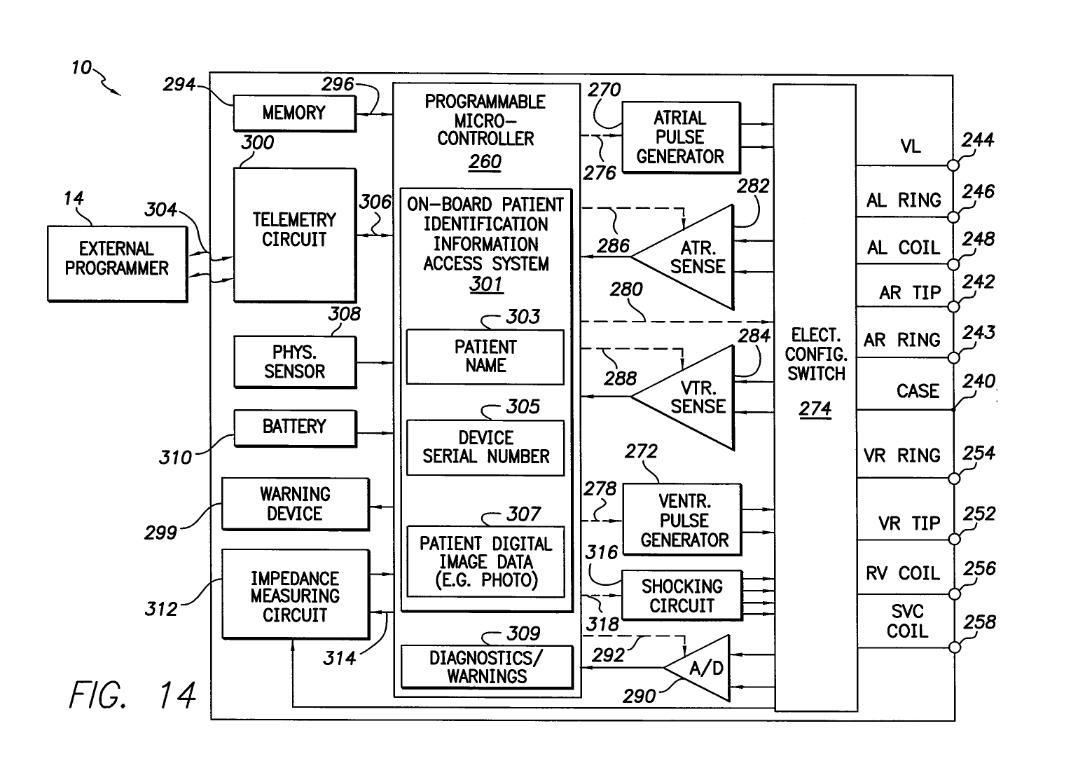

With reference to FIGS. 13 and 14, an exemplary CRMD will now be described where the CRMD is equipped to provide patient identifier data including, in some examples, photographic image data for the patient. FIG. 13 provides a simplified block diagram of a CRMD, which is a dual-chamber stimulation device capable of treating both fast and slow arrhythmias with stimulation therapy, including cardioversion, defibrillation and pacing stimulation. To provide atrial chamber pacing stimulation and sensing, CRMD 10 is in electrical communication with a heart 212 by way of a left atrial lead 220 having an atrial tip electrode 222 and an atrial ring electrode 223 implanted in the atrial appendage. CRMD 10 is also in electrical communication with the heart by way of a right ventricular lead 230 having, in this embodiment, a ventricular tip electrode 232, a right ventricular ring electrode 234, a right ventricular (RV) coil electrode 236, and a superior vena cava (SVC) coil electrode 238. Typically, the right ventricular lead 230 is transvenously inserted into the heart so as to place the RV coil electrode 236 in the right ventricular apex, and the SVC coil electrode 238 in the superior vena cava. Accordingly, the right ventricular lead is capable of receiving cardiac signals, and delivering stimulation in the form of pacing and shock therapy to the right ventricle.

To sense left atrial and ventricular cardiac signals and to provide left chamber pacing therapy, CRMD 10 is coupled to an LV lead 224 designed for placement in the “CS region” via the CS os for positioning a distal electrode adjacent to the left ventricle and/or additional electrode(s) adjacent to the left atrium. As used herein, the phrase “CS region” refers to the venous vasculature of the left ventricle, including any portion of the CS, great cardiac vein, left marginal vein, left posterior ventricular vein, middle cardiac vein, and/or small cardiac vein or any other cardiac vein accessible by the CS. Accordingly, the exemplary LV lead 224 is designed to receive atrial and ventricular cardiac signals and to deliver left ventricular pacing therapy using a pair of tip and ring electrodes 225 and 226, left atrial pacing therapy using at least a left atrial ring electrode 227, and shocking therapy using at least a left atrial coil electrode 228. In other examples, more or fewer LV electrodes are provided. Although only three leads are shown in FIG. 13, it should also be understood that additional leads (with one or more pacing, sensing and/or shocking electrodes) might be used and/or additional electrodes might be provided on the leads already shown, such as additional electrodes on the RV lead. Note that, on present commercially-available hardware, there is often no separate electrode 227.

A simplified block diagram of internal components of CRMD 10 is shown in FIG. 14. While a particular CRMD is shown, this is for illustrative purposes only, and one of skill in the art could readily duplicate, eliminate or disable the appropriate circuitry in any desired combination to provide a device capable of treating the appropriate chamber(s) with cardioversion, defibrillation and pacing stimulation. The housing 240 for CRMD 10, shown schematically in FIG. 14, is often referred to as the “can”, “case” or “case electrode” and may be programmably selected to act as the return electrode for all “unipolar” modes. The housing 240 may further be used as a return electrode alone or in combination with one or more of the coil electrodes, 228, 236 and 238, for shocking purposes. The housing 240 further includes a connector (not shown) having a plurality of terminals, 242, 243, 244, 245, 246, 248, 252, 254, 256 and 258 (shown schematically and, for convenience, the names of the electrodes to which they are connected are shown next to the terminals). As such, to achieve right atrial sensing and pacing, the connector includes at least a right atrial tip terminal (A_{R} TIP) 242 adapted for connection to the atrial tip electrode 222 and a right atrial ring (A_{R} RING) electrode 243 adapted for connection to right atrial ring electrode 223. To achieve left chamber sensing and pacing, the connector includes, at least, left ventricular tip and ring terminals 244 and 245, respectively.

The connector also includes a left atrial ring terminal (_{AL} RING) 246 and a left atrial shocking terminal (_{AL} COIL) 248, which are adapted for connection to the left atrial ring electrode 227 and the left atrial coil electrode 228, respectively. To support right chamber sensing, pacing and shocking, the connector further includes a right ventricular tip terminal (_{VR} TIP) 252, a right ventricular ring terminal (_{VR} RING) 254, a right ventricular shocking terminal (RV COIL) 256, and an SVC shocking terminal (SVC COIL) 258, which are adapted for connection to the RV tip electrode 232, right ventricular ring electrode 234, the _{VR} coil electrode 236, and the SVC coil electrode 238, respectively.

At the core of CRMD 10 is a programmable microcontroller 260, which controls the various modes of stimulation therapy. As is well known in the art, the microcontroller 260 (also referred to herein as a control unit) typically includes a microprocessor, or equivalent control circuitry, designed specifically for controlling the delivery of stimulation therapy and may further include RAM or ROM memory, logic and timing circuitry, state machine circuitry, and I/O circuitry. Typically, the microcontroller 260 includes the ability to process or monitor input signals (data) as controlled by a program code stored in a designated block of memory. The details of the design and operation of the microcontroller 260 are not critical to the invention. Rather, any suitable microcontroller 260 may be used that carries out the functions described herein. The use of microprocessor-based control circuits for performing timing and data analysis functions are well known in the art.

As shown in FIG. 14, an atrial pulse generator 270 and a ventricular pulse generator 272 generate pacing stimulation pulses for delivery by the right atrial lead 220, the right ventricular lead 230, and/or the LV lead 224 via an electrode configuration switch 274. It is understood that in order to provide stimulation therapy in each of the four chambers of the heart, the atrial and ventricular pulse generators, 270 and 272, may include dedicated, independent pulse generators, multiplexed pulse generators or shared pulse generators. The pulse generators, 270 and 272, are controlled by the microcontroller 260 via appropriate control signals, 276 and 278, respectively, to trigger or inhibit the stimulation pulses.

The microcontroller 260 further includes timing control circuitry (not separately shown) used to control the timing of such stimulation pulses (e.g., pacing rate, AV delay, atrial interconduction (inter-atrial) delay, or ventricular interconduction (V-V) delay, etc.) as well as to keep track of the timing of refractory periods, blanking intervals, noise detection windows, evoked response windows, alert intervals, marker channel timing, etc., which is well known in the art. Switch 274 includes a plurality of switches for connecting the desired electrodes to the appropriate I/O circuits, thereby providing complete electrode programmability. Accordingly, the switch 274, in response to a control signal 280 from the microcontroller 260, determines the polarity of the stimulation pulses (e.g., unipolar, bipolar, combipolar, etc.) by selectively closing the appropriate combination of switches (not shown) as is known in the art. The switch also switches among the various LV electrodes.

Atrial sensing circuits 282 and ventricular sensing circuits 284 may also be selectively coupled to the right atrial lead 220, LV lead 224, and the right ventricular lead 230, through the switch 274 for detecting the presence of cardiac activity in each of the four chambers of the heart. Accordingly, the atrial (ATR. SENSE) and ventricular (VTR. SENSE) sensing circuits, 282 and 284, may include dedicated sense amplifiers, multiplexed amplifiers or shared amplifiers. The switch 274 determines the “sensing polarity” of the cardiac signal by selectively closing the appropriate switches, as is also known in the art. In this way, the clinician may program the sensing polarity independent of the stimulation polarity. Each sensing circuit, 282 and 284, preferably employs one or more low power, precision amplifiers with programmable gain and/or automatic gain control, bandpass filtering, and a threshold detection circuit, as known in the art, to selectively sense the cardiac signal of interest. The automatic gain control enables CRMD 10 to deal effectively with the difficult problem of sensing the low amplitude signal characteristics of atrial or ventricular fibrillation. The outputs of the atrial and ventricular sensing circuits, 282 and 284, are connected to the microcontroller 260 which, in turn, are able to trigger or inhibit the atrial and ventricular pulse generators, 270 and 272, respectively, in a demand fashion in response to the absence or presence of cardiac activity in the appropriate chambers of the heart.

For arrhythmia detection, CRMD 10 utilizes the atrial and ventricular sensing circuits, 282 and 284, to sense cardiac signals to determine whether a rhythm is physiologic or pathologic. As used in this section “sensing” is reserved for the noting of an electrical signal, and “detection” is the processing of these sensed signals and noting the presence of an arrhythmia. The timing intervals between sensed events (e.g., AS, VS, and depolarization signals associated with fibrillation which are sometimes referred to as “F-waves” or “Fib-waves”) are then classified by the microcontroller 260 by comparing them to a predefined rate zone limit (i.e., bradycardia, normal, atrial tachycardia, atrial fibrillation, low rate VT, high rate VT, and fibrillation rate zones) and various other characteristics (e.g., sudden onset, stability, physiologic sensors, and morphology, etc.) in order to determine the type of remedial therapy that is needed (e.g., bradycardia pacing, antitachycardia pacing, cardioversion shocks or defibrillation shocks).

Cardiac signals are also applied to the inputs of an analog-to-digital (A/D) data acquisition system 290. The data acquisition system 290 is configured to acquire the IEGM signals, convert the raw analog data into a digital signal, and store the digital signals for later processing and/or telemetric transmission to an external device 14. The data acquisition system 290 is coupled to the right atrial lead 220, the LV lead 224, and the right ventricular lead 230 through the switch 274 to sample cardiac signals across any pair of desired electrodes. The microcontroller 260 is further coupled to a memory 294 by a suitable data/address bus 296, wherein the programmable operating parameters used by the microcontroller 260 are stored and modified, as required, in order to customize the operation of CRMD 10 to suit the needs of a particular patient. Such operating parameters define, for example, the amplitude or magnitude, pulse duration, electrode polarity, for both pacing pulses and impedance detection pulses as well as pacing rate, sensitivity, arrhythmia detection criteria, and the amplitude, waveshape and vector of each shocking pulse to be delivered to the patient's heart within each respective tier of therapy. Other pacing parameters include base rate, rest rate and circadian base rate.

Advantageously, the operating parameters of the implantable CRMD 10 may be non-invasively programmed into the memory 294 through a telemetry circuit 300 in telemetric communication with the external device 14, such as a programmer, transtelephonic transceiver, a diagnostic system analyzer or other EI. The telemetry circuit 300 is activated by the microcontroller by a control signal 306. The telemetry circuit 300 advantageously allows intracardiac electrograms and status information relating to the operation of CRMD 10 (as contained in the microcontroller 260 or memory 294) to be sent to the external device 14 through an established communication link 304. CRMD 10 further includes an accelerometer or other physiologic sensor 308, commonly referred to as a “rate-responsive” sensor because it is typically used to adjust pacing stimulation rate according to the exercise state of the patient. However, the physiological sensor 308 may further be used to detect changes in cardiac output, changes in the physiological condition of the heart, or diurnal changes in activity (e.g., detecting sleep and wake states) and to detect arousal from sleep. Accordingly, the microcontroller 260 responds by adjusting the various pacing parameters (such as rate, AV delay, VV delay, etc.) at which the atrial and ventricular pulse generators, 270 and 272, generate stimulation pulses. While shown as being included within CRMD 10, it is to be understood that the physiologic sensor 308 may also be external to CRMD 10, yet still be implanted within or carried by the patient. A common type of rate responsive sensor is an activity sensor incorporating an accelerometer or a piezoelectric crystal, which is mounted within the housing 240 of CRMD 10. Other types of physiologic sensors are also known, for example, sensors that sense the oxygen content of blood, respiration rate and/or minute ventilation, pH of blood, ventricular gradient, contractility, mechanical dyssynchrony, electrical dyssynchrony, photoplethysmography (PPG), heart sounds, etc.

The CRMD additionally includes a battery 310, which provides operating power to all of the circuits shown in FIG. 14. The battery 310 may vary depending on the capabilities of CRMD 10. If the system only provides low voltage therapy, a lithium iodine or lithium copper fluoride cell typically may be utilized. For exemplary CRMD 10, which employs shocking therapy, the battery 310 should be capable of operating at low current drains for long periods, and then be capable of providing high-current pulses (for capacitor charging) when the patient requires a shock pulse. The battery 310 should also have a predictable discharge characteristic so that elective replacement time can be detected. Accordingly, appropriate batteries are employed.

As further shown in FIG. 14, CRMD 10 has an impedance measuring circuit 312, enabled by the microcontroller 260 via a control signal 314. Uses for an impedance measuring circuit include, but are not limited to, lead impedance surveillance during the acute and chronic phases for proper lead positioning or dislodgement; detecting operable electrodes and automatically switching to an operable pair if dislodgement occurs; measuring respiration or minute ventilation; measuring thoracic impedance for determining shock thresholds; detecting when the device has been implanted; measuring respiration; detecting the motion of heart valves; and detecting cardiogenic impedance, etc. Impedance measuring circuit 312 is coupled to switch 274 so that any desired electrode may be used.

In the case where CRMD 10 is intended to operate as an ICD device, it detects the occurrence of an arrhythmia requiring a shock, and automatically applies an appropriate electrical shock therapy to the heart aimed at terminating the arrhythmia. To this end, the microcontroller 260 further controls a shocking circuit 316 by way of a control signal 318. The shocking circuit 316 generates shocking pulses of low (up to 0.5 joules), moderate (0.5-10 joules) or high energy (11 to 40 joules or more), as controlled by the microcontroller 260. Such shocking pulses are applied to the heart of the patient through at least two shocking electrodes, and as shown in this embodiment, selected from the left atrial coil electrode 228, the RV coil electrode 236, and/or the SVC coil electrode 238. The housing 240 may act as an active electrode in combination with the RV electrode 236, or as part of a split electrical vector using the SVC coil electrode 238 or the left atrial coil electrode 228 (i.e., using the RV electrode as a common electrode). Cardioversion shocks are generally considered to be of low to moderate energy level (so as to minimize pain felt by the patient), and/or synchronized with an R-wave and/or pertaining to the treatment of tachycardia. Defibrillation shocks are generally of moderate to high energy level (i.e., corresponding to thresholds in the range of 10-40 joules or more), delivered asynchronously (since R-waves may be too disorganized), and pertaining exclusively to the treatment of fibrillation. Accordingly, the microcontroller 260 is capable of controlling synchronous or asynchronous delivery of shocking pulses.

An internal warning device 299 may be provided for generating perceptible warning signals to the patient pertaining to cardiac rhythm irregularities or other issues. The warning signals are generated via vibration, voltage or other methods.

To facilitate patient and device identification, the microcontroller includes an on-board patient identification information access system 301 operative to access identification data (stored in memory 294) in response to interrogation signals or commands received from external system 14. In this particular example, the information access system includes a patient name access system 303 for accessing the patient name from memory (if recorded within the device), a device serial number access system 305 for accessing the device serial number, and a patient digital image data access system 307 for assessing patient image data (e.g. a digital photo) if recorded within the device. Information access system 301 then forwards the retrieved data to the telemetry circuit 300 for transmission to the external system. A diagnostic/warning controller 309 controls the generation and recordation of diagnostics/warnings pertaining to various conditions. For example, if the device fails to locate the needed identification data from memory, a suitable warning would be generated.

Depending upon the implementation, the various components of the microcontroller may be implemented as separate software modules or the modules may be combined to permit a single module to perform multiple functions. Although shown as components of the microcontroller, some or all of the components may be implemented separately from the microcontroller, using application specific integrated circuits (ASICs) or the like.

### Exemplary External Instrument

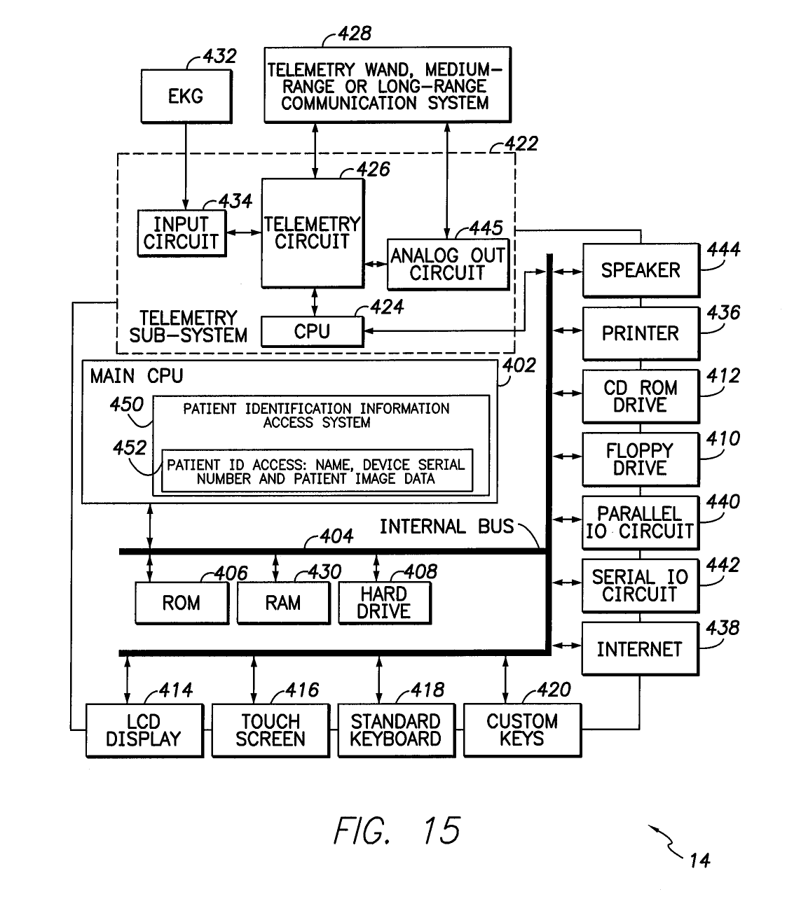

FIG. 15 illustrates pertinent components of an external programmer 14 for use in interrogating and programming the CRMD of FIGS. 13 and 14 and for performing the above-described photo-verification techniques. For the sake of completeness, other device programming functions are also described herein. Generally, the programmer permits a physician, clinician or other user to program the operation of the implanted device and to retrieve and display information received from the implanted device such as IEGM data and device diagnostic data. Additionally, the external programmer can be optionally equipped to receive and display electrocardiogram (EKG) data from separate external EKG leads that may be attached to the patient (assuming the patient is nearby.) Depending upon the specific programming of the external programmer, programmer 14 may also be capable of processing and analyzing data received from the implanted device and from the EKG leads to, for example, render preliminary diagnosis as to medical conditions of the patient or to the operations of the implanted device.

Now, considering the components of programmer 14, operations of the programmer are controlled by a CPU 402, which may be a generally programmable microprocessor or microcontroller or may be a dedicated processing device such as an application specific integrated circuit (ASIC) or the like. Software instructions to be performed by the CPU are accessed via an internal bus 404 from a read only memory (ROM) 406 and random access memory 430. Additional software may be accessed from a hard drive 408, floppy drive 410, and CD ROM drive 412, or other suitable permanent mass storage device. Depending upon the specific implementation, a basic input output system (BIOS) is retrieved from the ROM by CPU at power up. Based upon instructions provided in the BIOS, the CPU “boots up” the overall system in accordance with well-established computer processing techniques.

Insofar as photo-verification is concerned, main CPU 402 includes a patient identification information access system 450 operative to control the photo-verification procedures described above. System 450 includes, in this example, a patient ID access system that queries a patient database stored within a hard drive 408 to obtain patient image data based on the patient name and/or device serial number retrieved from the CRMD using a communication system 428. The digital photo is displayed using an LCD display 414. Once photo-verification is completed, the CPU displays a menu of programming options to the user via display 414 or other suitable computer display device. To this end, the CPU may, for example, display a menu of specific programmable parameters of the implanted device to be programmed or may display a menu of types of diagnostic data to be retrieved and displayed. In response thereto, the clinician enters various commands via either a touch screen 416 overlaid on the LCD display or through a standard keyboard 418 supplemented by additional custom keys 420, such as an emergency VVI (EVVI) key. The EVVI key sets the implanted device to a safe VVI mode with high pacing outputs. This ensures life sustaining pacing operation in nearly all situations but by no means is it desirable to leave the implantable device in the EVVI mode at all times.

Typically, following photo-verification, the clinician controls the programmer 14 to retrieve data stored within any implanted devices and to also retrieve EKG data from EKG leads, if any, coupled to the patient. To this end, CPU 402 transmits appropriate signals to a telemetry subsystem 422, which provides components for directly interfacing with the implanted devices, and the EKG leads. Telemetry subsystem 422 may include its own separate CPU 424 for coordinating the operations of the telemetry subsystem. Main CPU 402 of programmer communicates with telemetry subsystem CPU 424 via internal bus 404. Telemetry subsystem additionally includes a telemetry circuit 426 connected to communication system 428, which may include a telemetry wand, medium-range or long-range RF communication system, which, in turn, receives and transmits signals electromagnetically from the telemetry unit of the implanted device. (If a short-range telemetry wand is employed, it is placed over the chest of the patient near the implanted device to permit reliable transmission of data between the telemetry wand and the implanted device.) The telemetry subsystem is shown as also including an input circuit 434 for receiving surface EKG signals from surface EKG system 432. In other implementations, no EKG circuit is provided.

Following the above-described photo-verification steps, the external programming device controls the implanted devices via appropriate signals generated by the telemetry system to output all previously recorded patient and device diagnostic information. Patient diagnostic information includes, for example, recorded IEGM data and statistical patient data such as the percentage of paced versus sensed heartbeats. Device diagnostic data includes, for example, information representative of the operation of the implanted device such as lead impedances, battery voltages, battery recommended replacement time (RRT) information and the like. Data retrieved from the CRMD also includes the data stored within the recalibration database of the CRMD (assuming the CRMD is equipped to store that data.) Data retrieved from the implanted devices is stored by external programmer 14 either within a random access memory (RAM) 430, hard drive 408 or within a floppy diskette placed within floppy drive 410. Additionally, or in the alternative, data may be permanently or semi-permanently stored within a compact disk (CD) or other digital media disk, if the overall system is configured with a drive for recording data onto digital media disks, such as a write once read many (WORM) drive.

Once all patient and device diagnostic data previously stored within the implanted devices is transferred to programmer 14, the implanted devices may be further controlled to transmit additional data in real time as it is detected by the implanted devices, such as additional IEGM data, lead impedance data, and the like. Additionally, or in the alternative, telemetry subsystem 422 receives EKG signals from EKG leads 432 via an EKG processing circuit 434. As with data retrieved from the implanted device itself, signals received from the EKG leads are stored within one or more of the storage devices of the external programmer. Typically, EKG leads output analog electrical signals representative of the EKG. Accordingly, EKG circuit 434 includes analog to digital conversion circuitry for converting the signals to digital data appropriate for further processing within the programmer. Depending upon the implementation, the EKG circuit may be configured to convert the analog signals into event record data for ease of processing along with the event record data retrieved from the implanted device. Typically, signals received from the EKG leads are received and processed in real time.

Thus, in this example, the programmer receives data both from implanted devices and from optional external EKG leads. Data retrieved from the implanted devices includes parameters representative of the current programming state of the implanted devices. Under the control of the clinician, the external programmer displays the current programmable parameters and permits the clinician to reprogram the parameters. To this end, the clinician enters appropriate commands via any of the aforementioned input devices and, under control of CPU 402, the programming commands are converted to specific programmable parameters for transmission to the implanted devices via telemetry system 428 to thereby reprogram the implanted devices. Prior to reprogramming specific parameters, the clinician may control the external programmer to display any or all of the data retrieved from the implanted devices or from the EKG leads, including displays of EKGs, IEGMs, and statistical patient information. Any or all of the information displayed by programmer may also be printed using a printer 436.

Programmer/monitor 14 also includes an Internet connection 438 to permit direct transmission of data to other programmers via the public switched telephone network (PSTN) or other interconnection line, such as a T1 line, fiber optic cable, Wi-Fi, cellular network, etc. Depending upon the implementation, the modem may be connected directly to internal bus 404 may be connected to the internal bus via either a parallel port 440 or a serial port 442. Other peripheral devices may be connected to the external programmer via parallel port 440 or a serial port 442 as well. Although one of each is shown, a plurality of input output (IO) ports might be provided. A speaker 444 is included for providing audible tones to the user, such as a warning beep in the event improper input is provided by the clinician. Telemetry subsystem 422 additionally includes an analog output circuit 445 for controlling the transmission of analog output signals, such as IEGM signals output to an EKG machine or chart recorder.

With the programmer configured as shown, a clinician or other user operating the external programmer is capable of retrieving, processing and displaying a wide range of information received from the implanted device and to reprogram the implanted device if needed. The descriptions provided herein with respect to FIG. 15 are intended merely to provide an overview of the operation of programmer and are not intended to describe in detail every feature of the hardware and software of the programmer and is not intended to provide an exhaustive list of the functions performed by the programmer. Note that the device programmer of FIG. 15 may also be used to review archived data for patients, i.e. data that has been previously downloaded. In other examples, such archived data might instead be displayed via a laptop or desktop computer system, or other computer devices such a tablet devices, smartphones, etc.

In general, while the invention has been described with reference to particular embodiments, modifications can be made thereto without departing from the scope of the invention. Note also that the term “including” as used herein is intended to be inclusive, i.e. “including but not limited to.”

What is claimed is:

1. A method for use by an external system equipped to communicate with implantable medical devices for implant within patients, the method comprising:
receiving data from an implantable device implanted within a patient, including identifier data;
based on the identifier data, retrieving an image representative of the particular patient in which the device is implanted; and
displaying the retrieved image to allow visual verification that the data received by the external system corresponds to an intended patient.

2. The method of claim 1 wherein the identifier data received from the implanted device identifies the particular device implanted within the patient.

3. The method of claim 2 wherein the identifier data includes a serial number of the implanted device.

4. The method of claim 1 wherein the external system identifies the particular patient in which the device is implanted based on the identifier data and then retrieves a stored image of the patient for verification display.

5. The method of claim 4 wherein the external system includes a database in which patient images are stored, the external system retrieving the image of the particular patient from its database.

6. The method of claim 4 wherein the external system retrieves the image of the particular patient from a remote database.

7. The method of claim 1 wherein the identifier data received from the implanted device includes the name of the particular patient.

8. The method of claim 1 wherein receiving data from an implantable device implanted within a patient is performed as part of an interrogation procedure to retrieve data from the implantable device of one particular patient.

9. The method of claim 8 further including receiving input from a user of the external system acknowledging that the image displayed corresponds to the particular patient whose device is being interrogated and, in response thereto, enabling programming of the implanted device.

10. The method of claim 1 wherein receiving data from an implantable device implanted within a patient is performed as part of a pre-interrogation procedure to identify all implantable devices within range of the external system.

11. The method of claim 10 wherein images of a plurality of patients with implantable devices within range of the external system are displayed so that a user of the external system can select one for interrogation.

12. The method of claim 1 wherein the image representative of the particular patient includes a digital photograph of the patient.

13. The method of claim 12 wherein the digital photograph includes a representation of the face of the patient.

14. The method of claim 1 wherein retrieving the image representative of the particular patient in which the device is implanted and displaying the retrieved image is performed during a post-implant follow up session with the patient.

15. The method of claim 1 wherein retrieving the image representative of the particular patient in which the device is implanted and displaying the retrieved image is performed during review of archived data.

16. The method of claim 1 wherein displaying the image representative of the particular patient in which the device is implanted is performed using a web browser.

17. The method of claim 1 wherein receiving data from the implantable device implanted is performed using one or more of short-range, medium-range or long-range telemetry.

18. An external system for use with implantable medical devices for implant within patients, the external system comprising:
a data input system operative to receive data from an implantable device implanted within a patient, including identifier data;
an image retrieval system operative, based on the identifier data, to retrieve an image representative of the particular patient in which the device is implanted; and
an image display system operative to display the retrieved image to allow visual verification that the data received by the external system corresponds to an intended patient.

19. A method for use by an external system equipped to communicate with implantable medical devices for implant within patients, the method comprising:
receiving data from an implantable device implanted within a patient, including an image representative of the particular patient in which the device is implanted; and
displaying the received image to allow visual verification that the data received by the external system corresponds to an intended patient.

20. An external system for use with implantable medical devices for implant within patients, the external system comprising:
a data input system operative to receive data from an implantable device implanted within a patient, including an image representative of the particular patient in which the device is implanted; and
an image display system operative to display the received image to allow visual verification that the data received by the external system corresponds to an intended patient.
